(19) United States
(12) Patent Application Publication
(10) Pub. No.: US 2026/0056826 A1
(43) Pub. Date: Feb. 26, 2026

(54) INFORMATION MANAGEMENT APPARATUS, SYSTEM, METHOD, AND STORAGE MEDIUM

(71) Applicant: CANON KABUSHIKI KAISHA, Tokyo (JP)

(72) Inventor: KEI TAMAGAWA, Tokyo (JP)

(21) Appl. No.: 19/301,404

(22) Filed: Aug. 15, 2025

(30) Foreign Application Priority Data
Aug. 23, 2024 (JP) 2024-143132

(51) Int. Cl. G06F 11/07

(52) U.S. Cl. CPC G06F 11/079; G06F 11/0733

(57) ABSTRACT

An information management apparatus that manages data, communicates with an analysis apparatus that analyzes the data to generate an analysis result, and acquires analysis information from the analysis result includes an analysis request unit, an analysis result request unit, a determination unit configured to determine to acquire an analysis result in a case where a response to a request for the analysis result indicates successful completion of the analysis, request the analysis again in a case where a response to the request for the analysis result indicates an error, or request the analysis result again in a case where a response to the request for the analysis result indicates that the analysis has not been started yet or is in progress, and an analysis result acquisition unit configured to acquire the analysis result from the analysis apparatus.

### BACKGROUND

### Field of the Technology

The present disclosure relates to an information management apparatus, a system, a method, and a storage medium.

### Description of the Related Art

There has been use of an image management cloud service that receives images transmitted from terminals, such as a camera, a smartphone, a personal computer (hereinafter, referred to as a PC), and the like, by a user to manage the images. Further, in recent years, an image management cloud service that has a function of analyzing subjects in images to classify the images by subject has been available.

In recent cloud service development, highly versatile functions are implemented as microservices and are used by various services to reduce development and operating costs. The function of analyzing subjects in images to classify the images by subject is highly versatile. Thus, by implementing the function as a microservice, cost reduction as described above can be expected.

Japanese Patent No. 5895782, Japanese Patent Application Laid-Open No. 2018-120541, and Japanese Patent No. 5361750 each discuss a technique including a plurality of apparatuses that operate in coordination to provide functionality.

The technique discussed in Japanese Patent No. 5895782 relates to an analysis system that includes a client, an analysis server, a data server, and a communication apparatus communicating with the analysis server and the data server. In response to a user's request for analysis to the analysis server from the client, the analysis server performs analysis, allowing the user to receive an analysis result via the client.

The technique discussed in Japanese Patent Application Laid-Open No. 2018-120541 automates configuration during installation of a plurality of multifunctional peripherals in an office, in a system including a client, a case management server, a data management server, and the plurality of multifunctional peripherals. In the technique discussed in Japanese Patent Application Laid-Open No. 2018-120541, when the execution of an automatic configuration script is interrupted, the multifunctional peripherals request the case management server to generate a divided script for resuming the configuration process from the point of time of interruption. The plurality of multifunctional peripherals then receives and executes the generated divided script, enabling the continuation of the configuration process.

The technique discussed in Japanese Patent No. 5361750 relates to a medical system that includes a plurality of medical information apparatuses each in compliance with Digital Imaging and Communications in Medicine (DICOM). A computed tomography (CT) apparatus, a magnetic resonance imaging (MRI) apparatus, an image diagnosis apparatus, and the like are coordinated and operated via a network to enable a physician to make a diagnosis.

However, by isolating functions as microservices, a calling service and a called service are separated on the network. Thus, requests from each service and data transfer cannot be performed due to communication failures and the like in some cases. In a system including a plurality of apparatuses, it is important for the calling service to appropriately handle errors acquired from the called service in order to enhance availability of the system.

Japanese Patent No. 5898782 discusses a configuration of an analysis system but does not discuss error handling. Japanese Patent Application Laid-Open No. 2018-120541 discusses processing in a case where multifunctional peripherals request a case management server to generate a divided script but cannot acquire the divided script. However, in such a case, the multifunctional peripherals only wait, and handling of the error is not discussed. In the technique discussed in Japanese Patent No. 5361750, a medical-information communication-connection management apparatus transmits a request to medical information apparatuses and analyzes information about a response to the request to take countermeasures based on the analysis result. As countermeasures, an error message corresponding to an error type is acquired from an error correspondence table in which error types and error messages, stored in a countermeasure storage unit, are associated with each other, and the error message is displayed on a countermeasure display screen. No technique is discussed of performing recovery processing or the like based on the response information from the medical information apparatuses.

Thus, Japanese Patent No. 5895782, Japanese Patent Application Laid-Open No. 2018-120541, and Japanese Patent No. 5361750 do not discuss a technique for continuously providing data to a user as long as possible for how to recover processing based on response information after a request for the processing. Further, excessive repeated requests to the processing request destination increase load on a service of the processing request destination. In cooperative systems, avoidance of overload is also important. Japanese Patent No. 5895782, Japanese Patent Application Laid-Open No. 2018-120541, and Japanese Patent No. 5361750 do not discuss a technique for avoiding overload.

### SUMMARY

The present disclosure is made to solve the above-described issues, and is directed to providing an information management apparatus, a system, a method, and a program that can continue data provision to a user as long as possible and can prevent issuance of an unnecessary analysis request.

According to an aspect of the present disclosure, an information management apparatus that manages data, communicates with an analysis apparatus that analyzes the data to generate an analysis result, and acquires analysis information from the analysis result includes one or more memories storing one or more programs; and one or more processors that, upon execution of the stored one or more programs, are configured to function as: an analysis request unit configured to request an analysis of data from the analysis apparatus, an analysis result request unit configured to request an analysis result from the analysis apparatus, a determination unit configured to determine to acquire the analysis result in a case where a response to the request for the analysis result indicates successful completion of the analysis, request the analysis again in a case where a response to the request for the analysis result indicates an error, or request the analysis result again in a case where a response to the request for the analysis result indicates that the analysis has not been started yet or is in progress, and an analysis result acquisition unit configured to acquire the analysis result from the analysis apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a conceptual diagram illustrating an example of an information management system.

FIG. 2 is a diagram illustrating an example of a system configuration of the information management system.

FIG. 3 is a diagram illustrating an example of a hardware configuration of an information processing apparatus.

FIG. 4 is a diagram illustrating an example of a hardware configuration of a terminal.

FIG. 5 is a diagram illustrating an example of a logical configuration of the information management system.

FIG. 6 is a sequence diagram illustrating an example of a processing procedure in the information management system.

FIG. 7 is a diagram illustrating an example of a procedure of the processing in step S201 of FIG. 6 performed by the information management apparatus.

FIG. 8 is a diagram illustrating an example of a detailed procedure of the processing in step S201 of FIG. 6 performed by the information processing apparatus.

FIG. 9 is a diagram illustrating an example of a processing procedure in a waiting unit.

FIGS. 10A and 10B are conceptual diagrams each illustrating an example of a waiting time.

### DESCRIPTION OF THE EMBODIMENTS

The present disclosure will be described in detail based on an exemplary embodiment with reference to the accompanying drawings. Configurations described in the following exemplary embodiment are merely examples, and the present disclosure is not limited to the illustrated configurations.

A first exemplary embodiment of the present disclosure will now be described.

### <Concept of Information Management System 100>

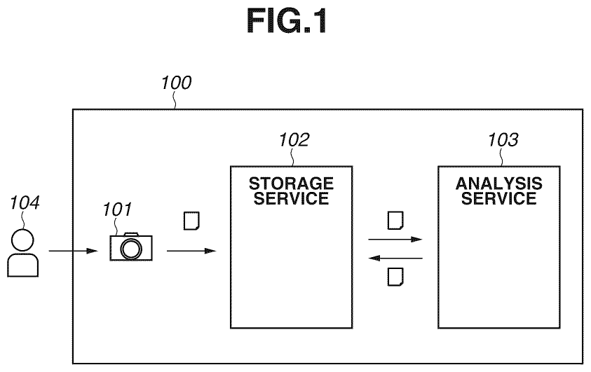

FIG. 1 is a conceptual diagram of an information management system 100 according to the present exemplary embodiment.

As illustrated in FIG. 1, the information management system 100 includes a camera 101, a storage service 102, and an analysis service 103.

A user 104 operates the camera 101 and uses the information management system 100.

The user 104 has an account for the storage service 102.

The camera 101 has a communication function and can transmit images to the storage service 102.

The storage service 102 has a communication function and can communicate with external apparatuses, such as the camera 101 and the analysis service 103. The storage service 102 manages images uploaded from the camera 101 by the user 104.

The analysis service 103 has a communication function and can communicate with the storage service 102.

A procedure in the information management system 100 according to the present exemplary embodiment will now be described.

The user 104 transmits an image stored in the camera 101 to the storage service 102.

The storage service 102 requests analysis of the received image from the analysis service 103.

The analysis service 103 acquires the image from the storage service 102 and analyzes the acquired image.

The storage service 102 requests an analysis result from the analysis service 103. If the analysis is completed, the storage service 102 acquires the analysis result from the analysis service 103.

The user 104 acquires the analysis result via the camera 101.

### <System Configuration of Information Management System 100>

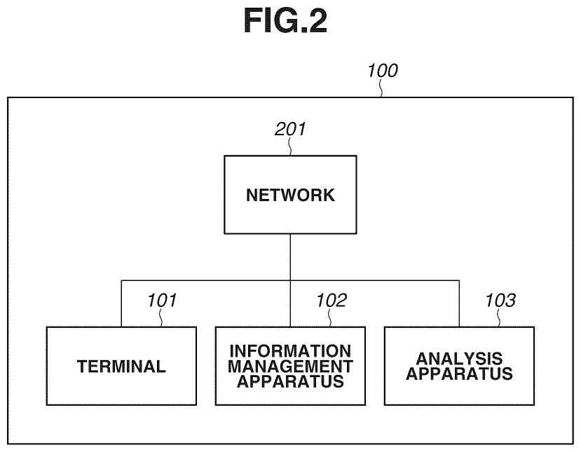

FIG. 2 illustrates a system configuration of the information management system 100 according to the present exemplary embodiment.

As illustrated in FIG. 2, the information management system 100 includes a terminal 101, an information management apparatus 102, an analysis apparatus 103, and a network 201. The terminal 101, the information management apparatus 102, and the analysis apparatus 103 respectively correspond to the camera 101, the storage service 102, and the analysis service 103 illustrated in FIG. 1.

The terminal 101, the information management apparatus 102, and the analysis apparatus 103 are connected via the network 201. The network 201 is implemented via, for example, a local area network (LAN) or the Internet and enables mutual communication among the connected apparatuses. The terminal 101 is described as an interchangeable lens digital camera, a compact digital camera, a smartphone, a tablet, or the like having a communication function. However, the terminal 101 is not limited thereto, and may be any terminal, for example, a personal computer (PC) having a communication function, that can transmit images to the information management apparatus 102.

### <Hardware Configuration of Information Processing Apparatus 300>

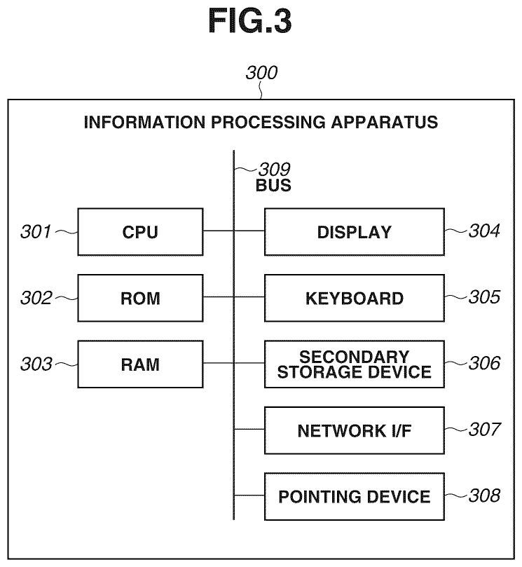

FIG. 3 is a diagram illustrating an example of a hardware configuration of an information processing apparatus 300 that functions as the information management apparatus 102 and the analysis apparatus 103. The information processing apparatus 300 includes a central processing unit (CPU) 301, a read-only memory (ROM) 302, a random-access memory (RAM) 303, a display 304, a keyboard 305, a secondary storage device 306, a network interface (I/F) 307, and a pointing device 308 that are connected to one another via a bus 309.

The CPU 301 is a calculation processing device that executes programs stored in the ROM 302 and the secondary storage device 306 to control the units connected via the bus 309. The ROM 302 is a read-only memory that stores an operating system (OS) and the like. The RAM 303 is a memory that temporarily stores data in calculation processing performed by the CPU 301. The display 304 displays a user interface (UI) screen and the like. The keyboard 305 and the pointing device 308 are input devices with which the user can perform various kinds of input operations. The secondary storage device 306 stores various kinds of programs, setting value data, a database (DB), captured image data, and the like. The network I/F 307 establishes a connection with a network, such as a LAN, an intranet, or the Internet.

### <Hardware Configuration of Terminal 101>

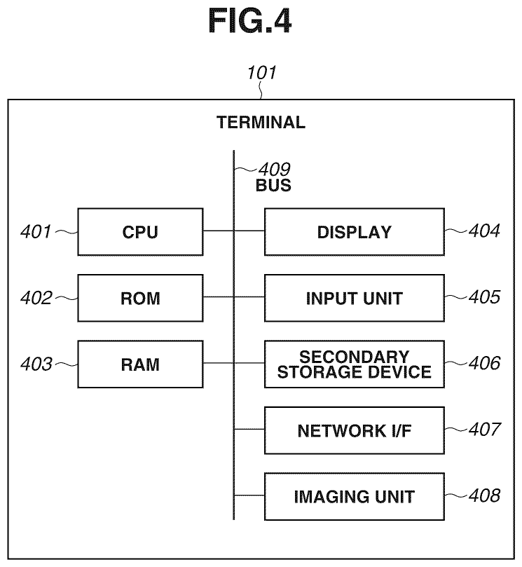

FIG. 4 is a diagram illustrating an example of a hardware configuration of the terminal 101. The terminal 101 includes a CPU 401, a ROM 402, a RAM 403, a display 404, an input unit 405, a secondary storage device 406, a network I/F 407, and an imaging unit 408 that are connected to one another via a bus 409. The terminal 101 is assumed to be an interchangeable lens digital camera or a compact digital camera but is not limited thereto. The terminal 101 may be a smartphone, a tablet terminal, or the like having a camera function. Further, the terminal 101 may be a PC. Depending on the PC, the imaging unit 408 may not be included.

The CPU 401 is a calculation processing device that executes programs stored in the ROM 402 and the secondary storage device 406 to control the units connected via the bus 409. The ROM 402 is a read-only memory that stores an OS and the like. The RAM 403 is a memory that temporarily stores data in calculation processing performed by the CPU 401. The display 404 displays information necessary for the user, such as captured images and various kinds of UI screens. The input unit 405 includes buttons, a touch panel, a microphone, and the like, and receives various user operations, such as an imaging instruction or various kinds of setting instructions. The secondary storage device 406 stores various kinds of programs, captured image data, setting values of imaging settings included in supplementary information, and the like. The imaging settings include International Organization for Standardization (ISO) sensitivity, shutter speed, exposure correction, F-number, and the like.

The network I/F 407 connects to a network, such as a LAN, an intranet, the Internet or the like. The imaging unit 408 is a module that converts light received by an image sensor, such as a charge-coupled device (CCD) or a complementary metal-oxide semiconductor (CMOS), into an electric signal to store the electric signal as an image.

### <Logical Configuration of Information Management System 100>

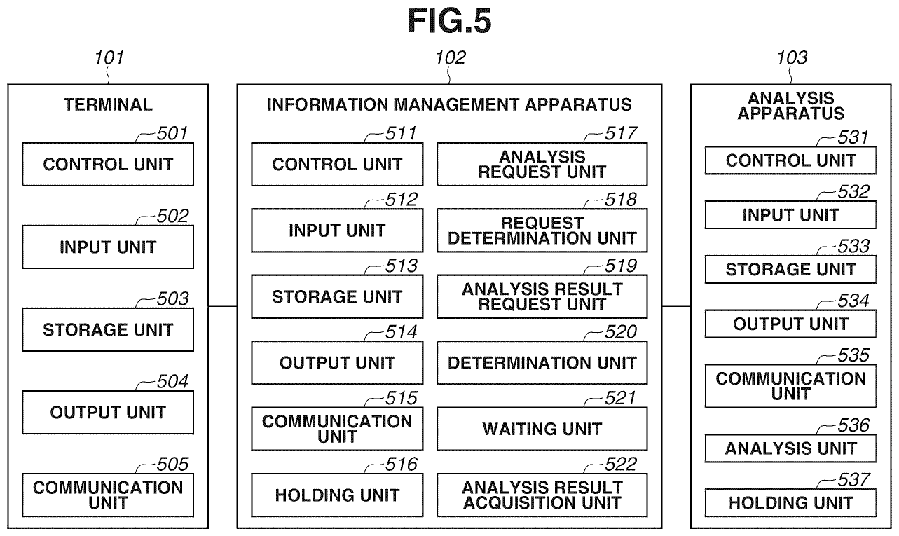

A logical configuration of the information management system 100 according to the present exemplary embodiment will now be described with reference to FIG. 5. The terminal 101 is a general PC, a smartphone, a tablet, or the like.

### «Logical Configuration of Terminal 101»

The logical configuration of the terminal 101 is implemented by the CPU 401 loading programs stored in the ROM 402 to the RAM 403 and performing processing following a sequence diagram and flowcharts described below. The RAM 403 holds execution results of portions of the processing.

The terminal 101 includes a control unit 501, an input unit 502, a storage unit 503, an output unit 504, and a communication unit 505. Each of the functional units will be described in the following.

The control unit 501 controls components of the terminal 101.

The input unit 502 receives inputs from the user.

The storage unit 503 stores a program for transmitting images to the information management apparatus 102, images to be transmitted to the information management apparatus 102, inputs from the user, and the like.

The output unit 504 displays an input screen of the program to transmit images to the information management apparatus 102, transmission results, summary information about the images in the information management apparatus 102, and the like.

The communication unit 505 communicates with the information management apparatus 102 via the program for transmitting images to the information management apparatus 102. The communication unit 505 performs transmission of images designated by the user, reception of information regarding a list of images managed by the information management apparatus 102, transmission of operations for the images managed by the information management apparatus 102, reception of operation results, and the like.

### «Logical Configuration of Information Management Apparatus 102»

The logical configuration of the information management apparatus 102 is implemented by the CPU 301 loading programs stored in the ROM 302 to the RAM 303 and performing processing following a sequence diagram and flowcharts described below. The RAM 303 holds execution results of portions of the processing.

The information management apparatus 102 includes a control unit 511, an input unit 512, a storage unit 513, an output unit 514, a communication unit 515, a holding unit 516, an analysis request unit 517, a request determination unit 518, an analysis result request unit 519, a determination unit 520, a waiting unit 521, and an analysis result acquisition unit 522. Each of the functional units will be described in the following.

The control unit 511 controls components of the information management apparatus 102.

The input unit 512 receives inputs from the user.

The storage unit 513 stores programs that operate in the information management apparatus 102, inputs from the terminal 101 and the analysis apparatus 103, and the like.

The output unit 514 outputs processing results in the information management apparatus 102, images held by the holding unit 516, and the like.

The communication unit 515 communicates with the terminal 101 and the analysis apparatus 103.

The holding unit 516 holds images received from the terminal 101, analysis results acquired from the analysis apparatus 103, and the like. In response to the holding unit 516 performing holding, the holding unit 516 issues an event. A processing block where settings have been configured for receiving issued events can receive a notification of the event via the issuance of the event.

The analysis request unit 517 requests analysis of images from the analysis apparatus 103.

The request determination unit 518 determines the subsequent processing in the information management apparatus 102 based on a response to an analysis request received from the analysis apparatus 103.

The analysis result request unit 519 requests analysis results from the analysis apparatus 103.

The determination unit 520 determines the subsequent processing in the information management apparatus 102 based on a response to a request for an analysis result.

The waiting unit 521 controls the time until an analysis result is requested based on the time elapsed since the issuance of the analysis request to the analysis apparatus 103.

The analysis result acquisition unit 522 acquires analysis results from the analysis apparatus 103.

### «Logical Configuration of Analysis Apparatus 103»

The logical configuration of the analysis apparatus 103 is implemented by the CPU 301 loading programs stored in the ROM 302 to the RAM 303 and performing processing following a sequence diagram and flowcharts described below. The RAM 303 holds execution results of portions of the processing.

The analysis apparatus 103 includes a control unit 531, an input unit 532, a storage unit 533, an output unit 534, a communication unit 535, an analysis unit 536, and a holding unit 537. Each of the functional units will be described in the following.

The control unit 531 controls components of the analysis apparatus 103.

The input unit 532 receives inputs from the user.

The storage unit 533 stores a program for transmitting images to the information management apparatus 102, images to be transmitted to the information management apparatus 102, inputs from the user, and the like.

The output unit 534 displays an input screen of the program for transmitting images to the information management apparatus 102, transmission results, summary information about the images in the information management apparatus 102, and the like.

The communication unit 535 communicates with the information management apparatus 102 via the program for transmitting images to the information management apparatus 102. The communication unit 535 performs transmission of images designated by the user, reception of information regarding a list of images managed by the information management apparatus 102, transmission of operations for the images managed by the information management apparatus 102, reception of operation results, and the like.

The analysis unit 536 analyzes images based on requests from the information management apparatus 102.

The holding unit 357 holds analysis results of the images.

Each of the functional units included in the terminal 101, the information management apparatus 102, and the analysis apparatus 103 may be implemented by a plurality of terminals and information processing apparatuses arranged in a distributed manner. When the functions are distributed among a plurality of information processing apparatuses, the plurality of information processing apparatuses is connected in a mutually communicable manner via a LAN or the like and performs a series of processing described below in coordination with one another.

### <Sequence of Information Management System 100>

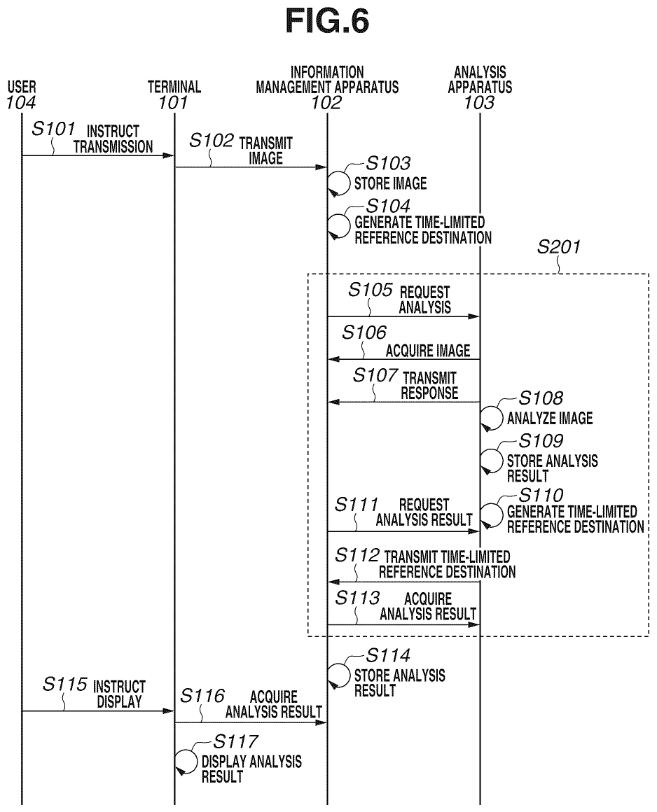

A processing procedure in the information management system 100 will be described with reference to the sequence diagram illustrated in FIG. 6.
In step S101, the terminal 101 receives an image transmission instruction from the user 104 via the input unit 502.
In step S102, the terminal 101 transmits a designated image to the information management apparatus 102 based on the image transmission instruction from the user 104.
In step S103, the information management apparatus 102 stores the image received from the terminal 101 in the holding unit 516. A storage event is issued in response to the storage processing.
In step S104, the information management apparatus 102 generates a time-limited reference destination for the stored image in response to the storage event. This is to securely transmit the reference destination for images to be analyzed to the analysis apparatus 103. An access right to the time-limited reference destination lapses when a set time limit is exceeded.
In step S105, the information management apparatus 102 transmits an image analysis request to the analysis apparatus 103, together with the generated time-limited reference destination.
In step S106, the analysis apparatus 103 refers to the time-limited reference destination received from the information management apparatus 102 to acquire the image to be analyzed.
In step S107, the analysis apparatus 103 transmits a response to the analysis request to the information management apparatus 102.
In step S108, the analysis apparatus 103 analyzes the image based on the analysis request from the information management apparatus 102.
In step S109, the analysis apparatus 103 stores an analysis result in the holding unit 537.
In step S110, the analysis apparatus 103 generates a time-limited reference destination for the stored analysis result.
In step S111, the information management apparatus 102 requests the analysis result from the analysis apparatus 103.
In step S112, the analysis apparatus 103 transmits the time-limited reference destination for the analysis result based on the analysis result request from the information management apparatus 102.
In step S113, the information management apparatus 102 refers to the time-limited reference destination received from the analysis apparatus 103 to acquire the analysis result.
In step S114, the information management apparatus 102 stores the acquired analysis result in the holding unit 516.
In step S115, the terminal 101 receives an instruction to display the analysis result from the user 104 via the input unit 502.
In step S116, the terminal 101 acquires the analysis result from the information management apparatus 102.
In step S117, the terminal 101 displays the acquired analysis result on the output unit 504.

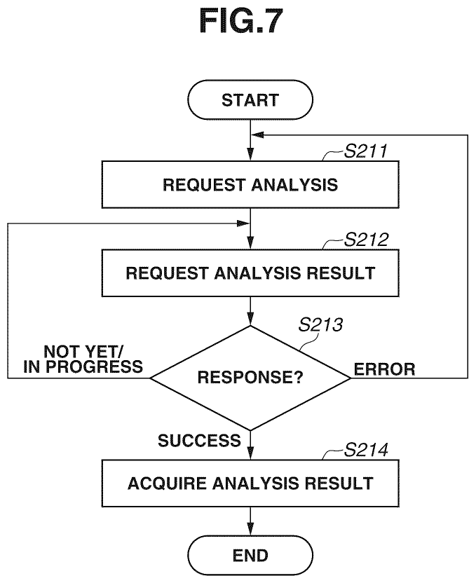

With the above-described processing, the user 104 can view the analysis result of the image.
Steps S105 to S113 are collectively referred to as step S201, and processing in step S201 will be described in detail with reference to FIG. 7.

### <Procedure of Processing in Step S201 of Information Management Apparatus 102>

A procedure of the processing in step S201 of the information management apparatus 102 will be described with reference to FIG. 7.
In step S211, the analysis request unit 517 requests image analysis from the analysis apparatus 103.
In step S212, the analysis result request unit 519 requests an analysis result from the analysis apparatus 103.
In step S213, the determination unit 520 determines the subsequent processing in the information management apparatus 102 based on a response to the analysis result request. If the response to the analysis result request indicates success (SUCCESS in step S213), the determination unit 520 determines to acquire the analysis result. If the response to the analysis result request indicates an error (ERROR in step S213), the determination unit 520 determines to request the analysis again. If the response to the analysis result request indicates that the analysis has not been started yet or is in progress (NOT YET/IN PROGRESS in step S213), the determination unit 520 determines to request an analysis result again.

Examples of error causes are as follows:
In a case where the analysis apparatus 103 fails to acquire an image from the information management apparatus 102
In a case where the analysis apparatus 103 fails to transmit an analysis result to the information management apparatus 102
In a case where the analysis apparatus 103 fails to issue a time-limited reference destination for transmitting an analysis result to the information management apparatus 102
In a case where an error occurs in internal processing of the analysis apparatus 103
In a case where a response from the analysis apparatus 103 is not returned for a predetermined time
In a case where a parameter is invalid when the information management apparatus 102 calls the analysis apparatus 103
In a case where an essential parameter is deficient when the information management apparatus 102 calls the analysis apparatus 103
In a case where a request header is deficient when the information management apparatus 102 calls the analysis apparatus 103
In a case where the type of a parameter is invalid when the information management apparatus 102 calls the analysis apparatus 103
In a case where the format of an image is not supported by the analysis apparatus 103
In a case where the execution of a library internally called by the analysis apparatus 103 fails
In a case where a call to a job management application programming interface (API) that issues a job identifier (ID) of a job for managing internal calls within the analysis apparatus 103 fails
In a case where an authentication fails when the analysis apparatus 103 accesses a time-limited reference destination
In a case where a communication path is not encrypted when the information management apparatus 102 communicates with the analysis apparatus 103
In a case where the information management apparatus 102 calls the analysis apparatus 103 with a request using a method other than a prescribed method
In a case where the information management apparatus 102 cannot acquire a job ID or an image ID

In step S214, the analysis result acquisition unit 522 acquires an analysis result from the analysis apparatus 103 to acquire analysis information from the analysis result. The analysis information includes at least the name of a classification to which a subject in the image belongs, and reliability of the classification. The analysis information is not limited to the name of the classification and can be an identifier corresponding to the name of the classification.

In the present exemplary embodiment, it is determined in step S213, in the case of an error, an analysis is to be requested again. However, the processing is not limited thereto. If the error is one of a system error, a timeout error, or a missing data error, the analysis result can be stored in the holding unit 516. This facilitates analysis of the error cause by an administrator after the error occurs.

### <Detailed Procedure of Processing in Step S201 of Information Management Apparatus 102>

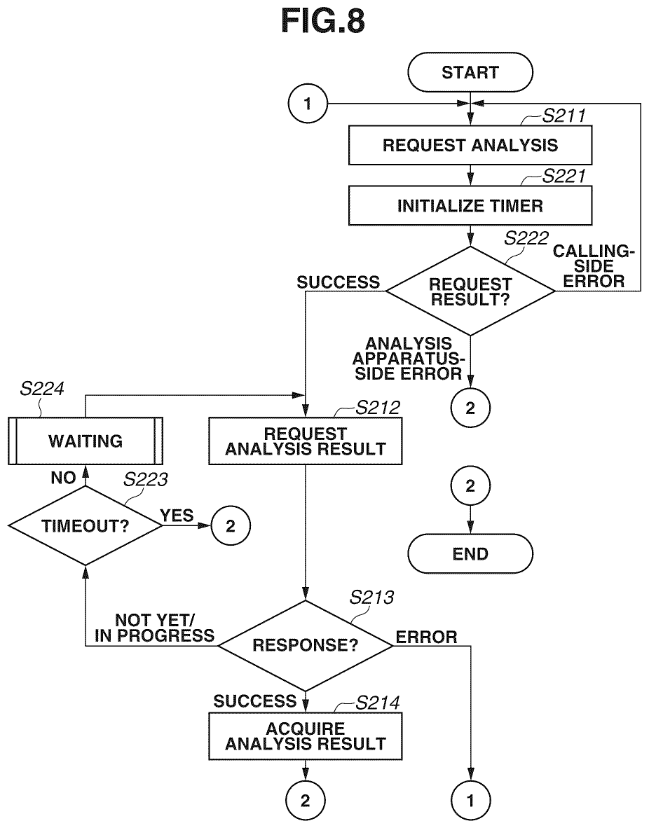

A detailed procedure of the processing in step S201 of the information management apparatus 102 will now be described with reference to FIG. 8. The same steps of the processing as those of the above-described processing are denoted by the same reference numerals, and the redundant description will be omitted.
In step S221, the control unit 511 initializes a timer that counts the elapsed time after an analysis is requested from the analysis apparatus 103.
In step S222, the request determination unit 518 determines whether to request an analysis result from the analysis apparatus 103 based on a response to the analysis request received after the analysis is requested from the analysis apparatus 103. If the request response indicates success (SUCCESS in step S222), the request determination unit 518 determines to request an analysis result from the analysis apparatus 103. If the request response indicates an error caused by the calling apparatus (information management apparatus 102) (CALLING-SIDE ERROR in step S222), the request determination unit 518 determines to request an analysis from the analysis apparatus 103 again. If the request response indicates an error caused by an analysis apparatus (analysis apparatus 103) (ANALYSIS APPARATUS-SIDE ERROR in step S222), the request determination unit 518 determines to end the processing of the information management apparatus 102. In a case where the request response indicates an error caused by an analysis apparatus, when the processing of the information management apparatus 102 ends, the processing is returned to the analysis apparatus to end normally. This is due to the constraints of a virtual PC on which the processing program of the request determination unit 518 operates. When the processing program running in the virtual PC ends abnormally, the virtual PC retries the processing. If the processing of the information management apparatus 102 is retried, the analysis request to the analysis apparatus 103 is issued a plurality of times. If the first analysis request is successful and the second analysis request is also successful, a plurality of analysis results is generated. On the other hand, if the processing program running in the virtual PC ends normally, the virtual PC does not retry the processing. In other words, a plurality of analysis results is not generated. Thus, in the present exemplary embodiment, the processing ends normally to prevent a plurality of analysis results from being generated.

Examples of errors caused by the analysis apparatus include the following:
In a case where the analysis apparatus 103 fails to acquire an image from the information management apparatus 102
In a case where the analysis apparatus 103 fails to transmit an analysis result to the information management apparatus 102
In a case where the analysis apparatus 103 fails to issue a time-limited reference destination for transmitting an analysis result to the information management apparatus 102
In a case where an error occurs in internal processing of the analysis apparatus 103
In a case where a response from the analysis apparatus 103 is not returned for a predetermined time

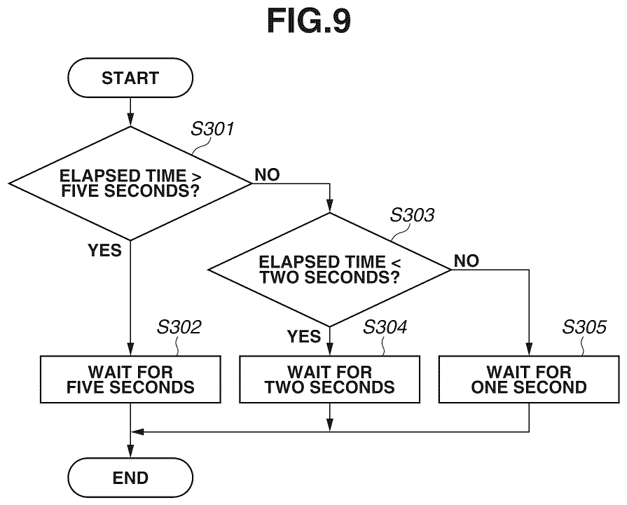

Examples of errors caused by the calling apparatus include the following:
In a case where a parameter is invalid when the information management apparatus 102 calls the analysis apparatus 103
In a case where an essential parameter is deficient when the information management apparatus 102 calls the analysis apparatus 103
In a case where a request header is deficient when the information management apparatus 102 calls the analysis apparatus 103
In a case where the type of a parameter is invalid when the information management apparatus 102 calls the analysis apparatus 103
In a case where the format of an image is not supported by the analysis apparatus 103
In a case where the execution of a library internally called by the analysis apparatus 103 fails
In a case where a call to the job management API that issues a job ID for a job for managing internal calls within the analysis apparatus 103 fails
In a case where an authentication fails when the analysis apparatus 103 accesses a time-limited reference destination
In a case where a communication path is not encrypted when the information management apparatus 102 communicates with the analysis apparatus 103
In a case where the information management apparatus 102 calls the analysis apparatus 103 with a request using a method other than a prescribed method
In a case where the information management apparatus 102 cannot acquire a job ID or an image ID
In step S223, the control unit 511 determines whether a predetermined time, for example, 130 seconds, has elapsed since the analysis request in step S211, i.e., whether a timeout occurs. If a timeout does not occur (NO in step S223), the processing proceeds to step S224. If a timeout occurs (YES in step S223), the processing of the information management apparatus 102 ends.
In step S224, the waiting unit 521 controls the time until an analysis result is requested based on the elapsed time since the analysis request. Details of the processing in the waiting unit 521 will be described with reference to FIG. 9.

### <Processing Procedure in Waiting Unit 521>

A processing procedure in the waiting unit 521 will now be described with reference to FIG. 9.
In step S301, the waiting unit 521 determines whether the elapsed time counted by the timer exceeds five seconds. If the elapsed time exceeds five seconds (YES in step S301), the processing proceeds to step S302. If the elapsed time is less than or equal to five seconds (NO in step S301), the processing proceeds to step S303.
In step S302, the waiting unit 521 waits five seconds for the processing.
In step S303, the waiting unit 521 determines whether the elapsed time counted by the timer is less than two seconds. If the elapsed time is less than two seconds (YES in step S303), the processing proceeds to step S304. If the elapsed time is greater than or equal to two seconds (NO in step S303), the processing proceeds to step S305.
In step S304, the waiting unit 521 waits two seconds for the processing.
In step S305, the waiting unit 521 waits one second for the processing.

The times to be compared with the elapsed time counted by the timer are set to five seconds and two seconds. However, the time to be compared, i.e., a threshold, is not limited thereto and may be set to six seconds and three seconds. Further, the waiting times of the processing are set to five seconds, two seconds, and one second, but are not limited thereto. The waiting times of the processing can be set to seven seconds, three seconds, and 0.5 seconds.

Furthermore, in a case where the response to an analysis result request indicates that the analysis has not been started yet or is in progress, when the elapsed time since the analysis request is within a first time section, the waiting unit 521 waits for the processing for a longer time than the waiting time when the elapsed time is within a second time section. When the elapsed time since the analysis request is within the second time section, the waiting unit 521 waits for the processing for a shorter time than the waiting times when the elapsed time is within the first time section or a third time section. When the elapsed time from the analysis request is within the third time section, the waiting unit 521 waits for the processing for a longer time than the waiting times when the elapsed time is within the first time section or the second time section.

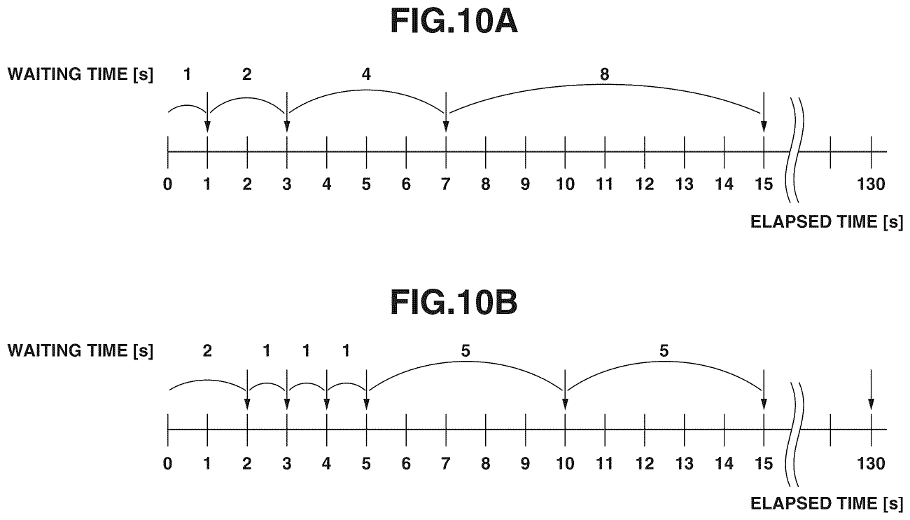

In a cloud service, exponential backoff is generally used to manage waiting times. FIG. 10A illustrates a concept of the waiting time in exponential backoff. In FIG. 10A, the horizonal axis represents the elapsed time. The unit of the elapsed time is seconds. In the elapsed time between zero seconds and one second, a re-request is issued at an interval of one second. In the elapsed time between one second and three seconds, a re-request is issued at an interval of two seconds. In the elapsed time is between three seconds and seven seconds, a re-request is issued at an interval of four seconds. In the elapsed time between seven seconds and 15 seconds, a re-request is issued at an interval of eight seconds. In other words, a waiting time is set exponentially relative to an elapsed time. This can produce the effect of reducing load on the service of the called apparatus. On the other hand, for example, in the case of an analysis service that tends to complete analysis after an elapsed time of three seconds, when the analysis is ended in an elapsed time of 3.1 seconds, the processing waits until seven seconds have elapsed. In contrast, in the present exemplary embodiment, the waiting time is shortened within the elapsed time range in which the analysis tends to be completed, while the waiting time within the earlier elapsed time range is extended. FIG. 10B illustrates a concept of the waiting times according to the present exemplary embodiment. Such a design of the waiting times reduces load on the analysis service within the elapsed time range in which the likelihood of analysis completion is low.

Further, by shortening the waiting time within the elapsed time range in which the likelihood of the analysis completion is high, the analysis result can be provided to the user quickly. In the above-described example, the analysis result can be provided in an elapsed time of four seconds. After an elapsed time of five seconds, the likelihood is high that an error or processing delay occurs on the analysis service. Thus, the waiting time is set to be extended.

This makes it possible to quickly provide the analysis result to the user and to reduce load on the analysis service. The method of designing waiting times is based on experimental results. Immediately after an analysis request is issued, it takes about two seconds to start the virtual PC that performs the analysis processing, and the analysis processing starts after the virtual PC startup. Thus, the analysis does not complete within the first two seconds. In the elapsed time range between two seconds and five seconds, the likelihood is high that the analysis is completed. On the other hand, there were observed phenomena that after an elapsed time of five seconds, an error occurred, and it took a long time to perform the analysis processing. These experimental results were obtained by performing processing of analyzing and classifying a subject in a Joint Photographic Experts Group (JPEG) image having a width of 2048 pixels by using a predetermined virtual PC. Even in a case where the analysis processing is performed under a condition different from the above-described condition, the optimum waiting time for the system can be designed by investigating a processing status at each elapsed time. A file size of the image is suitably less than 4 megabytes (MB). It is suitable for the sizes of both width and height to be between 50 pixels and less than 16,000 pixels.

In FIG. 10B, the waiting time after an elapsed time of five seconds is set to five seconds but is not limited thereto. The waiting time after an elapsed time of five seconds may be designed to be extended relative to the elapsed time, such as exponential backoff. Each time section and the waiting time are suitably set as follows:
the first time section is greater than or equal to zero seconds and less than two seconds
the second time section is greater than or equal to two seconds and less than five seconds
the third time section is greater than or equal to five seconds and less than or equal to 130 seconds
the processing waiting time in the first time section is two seconds
the processing waiting time in the second time section is one second
the processing waiting time in the third time section is five seconds

According to the technique described above, in a case where the response to an analysis result request indicates an error, the analysis is requested again, and in a case where the response to the analysis result request indicates that the analysis has not been started yet or is in progress, the analysis result is requested again. Thus, the issuance of an unnecessary analysis request to the analysis apparatus 103 can be prevented.

### Other Exemplary Embodiments

In the present exemplary embodiment, the information received by the information management apparatus 102 from the terminal 101 is an image but is not limited thereto. Any type of information can be used as long as the information is electronically represented, such as a video image, sound, a character string, three-dimensional data, or multi-dimensional data. In this case, it is necessary to appropriately replace, for example, the image format with a data format and the image ID with a data ID.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-143132, filed Aug. 23, 2024, the entirety of which is incorporated herein by reference.

What is claimed is:

1. An information management apparatus that manages data, communicates with an analysis apparatus that analyzes the data to generate an analysis result, and acquires analysis information from the analysis result, the information management apparatus comprising:
one or more memories storing one or more programs; and
one or more processors that, upon execution of the stored one or more programs, are configured to function as:
an analysis request unit configured to request an analysis of data from the analysis apparatus;
an analysis result request unit configured to request an analysis result from the analysis apparatus;
a determination unit configured to determine to acquire the analysis result in a case where a response to the request for the analysis result indicates successful completion of the analysis, request the analysis again in a case where a response to the request for the analysis result indicates an error, or request the analysis result again in a case where a response to the request for the analysis result indicates that the analysis has not been started yet or is in progress; and
an analysis result acquisition unit configured to acquire the analysis result from the analysis apparatus.

2. The information management apparatus according to claim 1, wherein the error occurs in at least one of a case where the analysis apparatus fails to acquire the data from the information management apparatus, a case where the analysis apparatus fails to transmit the analysis result to the information management apparatus, a case where the analysis apparatus fails to issue a time-limited reference destination for transmitting the analysis result to the information management apparatus, a case where an error occurs in internal processing of the analysis apparatus, a case where a response from the analysis apparatus is not returned for a predetermined time, a case where a parameter is invalid when the information management apparatus calls the analysis apparatus, a case where an essential parameter is deficient when the information management apparatus calls the analysis apparatus, a case where a request header is deficient when the information management apparatus calls the analysis apparatus, a case where a type of a parameter is invalid when the information management apparatus calls the analysis apparatus, a case where a data format of the data is not supported by the analysis apparatus, a case where execution of a library internally called by the analysis apparatus fails, a case where a call to a job management application programming interface (API) that issues a job identifier (ID) of a job for managing internal calls within the analysis apparatus fails, a case where an authentication fails when the analysis apparatus accesses the time-limited reference destination, a case where a communication path is not encrypted when the information management apparatus communicates with the analysis apparatus, a case where the information management apparatus calls the analysis apparatus with a request using a method other than a prescribed method, or a case where the information management apparatus is unable to acquire a job ID or a data ID.

3. The information management apparatus according to claim 1, wherein the determination unit is further configured to determine to store the analysis result in a case where a response to the request for the analysis result indicates any of a system error, a timeout error, or a missing data error.

4. The information management apparatus according to claim 1, wherein the one or more processors, upon execution of the stored one or more programs, are further configured to function as: a request determination unit configured to determine whether to request the analysis result from the analysis apparatus based on a response to the analysis request received after the analysis is requested from the analysis apparatus,
wherein the request determination unit determines to request the analysis result from the analysis apparatus in a case where a response to the analysis request indicates success, request the analysis from the analysis apparatus again in a case where a response to the analysis request indicates an error caused by the analysis apparatus, or end processing of the information management apparatus in a case where a response to the analysis request indicates an error caused by a calling apparatus.

5. The information management apparatus according to claim 4, wherein the error caused by the analysis apparatus is at least one of a case where the analysis apparatus fails to acquire the data from the information management apparatus, a case where the analysis apparatus fails to transmit the analysis result to the information management apparatus, a case where the analysis apparatus fails to issue a time-limited reference destination for transmitting the analysis result to the information management apparatus, a case where an error occurs in internal processing of the analysis apparatus, or a case where a response from the analysis apparatus is not returned for a predetermined time.

6. The information management apparatus according to claim 4, wherein the error caused by the calling apparatus is at least one of a case where a parameter is invalid when the information management apparatus calls the analysis apparatus, a case where an essential parameter is deficient when the information management apparatus calls the analysis apparatus, a case where a request header is deficient when the information management apparatus calls the analysis apparatus, a case where a type of a parameter is invalid when the information management apparatus calls the analysis apparatus, a case where a format of the data is not supported by the analysis apparatus, a case where execution of a library internally called by the analysis apparatus fails, a case where a call to a job management API that issues a job ID of a job for managing internal calls within the analysis apparatus fails, a case where an authentication fails when the analysis apparatus accesses a time-limited reference destination, a case where a communication path is not encrypted when the information management apparatus communicates with the analysis apparatus, a case where the information management apparatus calls the analysis apparatus with a request using a method other than a prescribed method, or a case where the information management apparatus is unable to acquire a job ID or a data ID.

7. The information management apparatus according to claim 4, wherein, in the case where a response to the analysis request indicates an error caused by a calling apparatus, when the processing of the information management apparatus ends, the request determination unit returns the processing to the calling apparatus to end the processing normally.

8. The information management apparatus according to claim 1, wherein the one or more processors, upon execution of the stored one or more programs, are further configured to function as: a waiting unit configured to control an amount of time until the analysis result is requested based on an elapsed time since the analysis was requested by the analysis request unit,
wherein, in a case where a response to the request for the analysis result indicates that the analysis has not been started yet or is in progress, when the elapsed time is within a first time section, the waiting unit waits for a longer amount of time than a waiting time within a second time section, when the elapsed time is within the second time section, the waiting unit waits for a shorter amount of time than the waiting time within the first time section and a third time section, and when the elapsed time is within the third time section, the waiting unit waits for a longer amount of time than the waiting time within the first time section and the second time section.

9. The information management apparatus according to claim 8,
wherein the data is an image, and
wherein the analysis information acquired from the analysis result includes a name of a classification to which a subject in the image belongs or an identifier corresponding to the name of the classification, and reliability of the classification.

10. The information management apparatus according to claim 9,
wherein a file size of the image is less than 4 megabytes (MB), and sizes of both width and height of the image are greater than or equal to 50 pixels and less than 16,000 pixels,
wherein the first time section is greater than or equal to zero seconds and less than two seconds,
wherein the second time section is greater than or equal to two seconds and less than five seconds,
wherein the third time section is greater than or equal to five seconds and less than 130 seconds,
wherein a processing waiting time in the first time section is two seconds,
wherein a processing waiting time in the second time section is one second, and
wherein a processing waiting time in the third time section is five seconds.

11. An information management method of communicating with an analysis apparatus that analyzes data to generate an analysis result, acquiring analysis information from the analysis result, and managing the analysis result, the information management method comprising:
requesting an analysis of data from the analysis apparatus;
requesting an analysis result from the analysis apparatus;
determining to acquire the analysis result in a case where a response to the request for the analysis result indicates successful completion of the analysis, request the analysis again in a case where a response to the request for the analysis result indicates at least an error including information indicating that the analysis apparatus has failed to acquire the data from an information management apparatus, and request the analysis result again in a case where a response to the request for the analysis result indicates that the analysis has not been started yet or is in progress; and
acquiring the analysis result from the analysis apparatus.

12. A non-transitory computer-readable storage medium storing a program for causing an information management apparatus to execute an information management method, the information management apparatus communicating with an analysis apparatus that analyzes data to generate an analysis result, acquiring analysis information from the analysis result, and managing the analysis information, the information management method comprising:
requesting an analysis of data from the analysis apparatus;
requesting an analysis result from the analysis apparatus;
determining to acquire the analysis result in a case where a response to the request for the analysis result indicates successful completion of the analysis, request the analysis again in a case where a response to the request for the analysis result indicates at least an error including information indicating that the analysis apparatus has failed to acquire the data from the information management apparatus, and request the analysis result again in a case where a response to the request for the analysis result indicates that the analysis has not been started yet or is in progress; and
acquiring the analysis result from the analysis apparatus.

13. An information management system for communicating with an analysis apparatus that analyzes data to generate an analysis result, acquiring analysis information from the analysis result, and managing the analysis result, the information management system comprising:
one or more memories storing one or more programs; and
one or more processors that, upon execution of the stored one or more programs, cause the information management system to:
request an analysis of data from the analysis apparatus;
request an analysis result from the analysis apparatus;
determine to acquire the analysis result in a case where a response to the request for the analysis result indicates successful completion of the analysis, request the analysis again in a case where a response to the request for the analysis result indicates at least an error including information indicating that the analysis apparatus has failed to acquire the data from the information management system, and request the analysis result again in a case where a response to the request for the analysis result indicates that the analysis has not been started yet or is in progress; and
acquire the analysis result from the analysis apparatus.
